(19) United States
(12) Patent Application Publication
(10) Pub. No.: US 2005/0254092 A1
(43) Pub. Date: Nov. 17, 2005

(54) Method for printing image in voluntary template paper, print management apparatus and print system using the same

(75) Inventor: Ki-Moon Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/117,495

(22) Filed: Apr. 29, 2005

(30) Foreign Application Priority Data
Apr. 30, 2004 (KR) 2004-30564

(51) Int. Cl. G06K 15/02

(52) U.S. Cl. 358/1.18

(57) ABSTRACT

A method for printing images on a voluntary template paper is disclosed. The method comprises the steps of a) scanning a paper having a predetermined template layout, b) selecting a predetermined image, c) arranging the selected image on the scanned template, and d) printing the template with the arranged image on the paper. Accordingly, images and text can be arranged in a template which is not provided by the application or which is designed by the user, and the arranged images and text with the template can be printed on the paper.

### CROSS-REFERENCE TO RELATED APPLICATION

This application claims the benefit under 35 U.S.C. §1 119(a) of Korean Patent Application No. 2004-30564, filed Apr. 30, 2004 in the Korean Intellectual Property Office, the entire disclosure of which is hereby incorporated by reference.

### BACKGROUND OF THE INVENTION

1. Field of the Invention

The present invention relates to a method for printing images. More particularly, the present invention relates to a method for arranging images or text in a template by using an application executed at a personal computer (PC) and printing the template with the arranged images or text on a template paper.

2. Description of the Related Art

Recently, compact disk (CD) recorders and digital cameras have become very popular because of their improved performance and moderate price. As the CD recorder and digital cameras have become popular, many useful tools have been introduced for producing a compact disk (CD) label. By using these tools with a printer and a personal computer (PC), the user can easily produce a CD label that includes an image such as a photo according to the user's preference.

For producing the CD label with a picture, a template paper and an appropriate application are required. The template paper is a paper including a predetermined layout of templates and the application is a computer executable software program for arranging images and text on templates. The application is typically distributed to the users by a manufacturer of the template paper. The user arranges images and text on templates in the predetermined layout of templates by executing the application and prints the template with the arranged images and text on the template paper to produce the CD label.

Hereinafter, a conventional method for producing the CD label using the application is explained. FIG. 1 is a flowchart for explaining a conventional method for printing images on a template paper and FIGS. 2A to 2C are diagrams showing windows provided during the execution of an application for arranging an image on a predetermined layout of templates and printing the templates with the arranged images on the template paper.

First, a user preferably executes the application on a personal computer (PC), a first “selection of template” window is displayed on a displayer display device of the PC as a user interface at step S10. An exemplary “selection of template” window is shown in FIG. 2A. The user selects one of the available templates in the first window at step S20. After selecting the desired template, a second “selection of image” window is displayed at the display device as shown in FIG. 2B and the user selects one of the available images in the second window at step S30. The selected image is automatically arranged in the selected template by the application at step S40 and the arranged image on the selected template is displayed at a third “preview” window for previewing the selected template with the arranged image. After previewing the selected template with the arranged image, a printer prints the previewed template with the arranged images on the template paper to produce a CD label at step S50.

As mentioned above, the user does not have many selections for producing the CD label. The user must select one of the templates provided by the application for producing the CD label.

There are currently no applications for designing templates and printing the designed template for all of the different kinds of template papers produced by various manufacturers because the application is typically produced and distributed by a manufacturer of a specific template paper. Therefore, the user inconveniently needs to install additional applications to use different kinds of template papers.

Furthermore, if the user has the template paper but does not have corresponding application, the user cannot easily produce a CD label for the particular type of label paper.

Moreover, the user cannot produce a unique CD label according to the tastes of the user since there are not many options for selection of images and templates in the application provided by the manufacturer of the template paper.

Generally, there is a small difference between a first location of the selected image on a template paper displayed on the display device and a second location of the selected image as printed on the actual template paper. Although the difference is very small, it can cause noticeable errors on the CD label. The above-mentioned difference between the first location and the second location can be reduced by producing the application based on known characteristics of the printer.

However, there have been various types of printers introduced from a number of manufacturers and existing applications do not take the various characteristics of the respective types of printers into consideration. That is, the user uses the application for producing the CD label for all types of printers. Therefore, the template with arranged images and text may be incorrectly printed on the template paper according to the type of printer.

### SUMMARY OF THE INVENTION

Accordingly, the present invention has been developed to solve the above-mentioned and/or problems, and an aspect of the present invention is to provide a method for arranging images and text on a template not provided from an application and printing the template with the arranged image and text on template paper.

In accordance with one aspect of the present invention, there is provided a method of printing, comprising the steps of a) scanning a paper having a predetermined template layout; b) selecting a predetermined image; c) arranging the selected image on the scanned predetermined template layout; and d) printing the template with the arranged image on the template paper. A template is the printable region of the CD label. The layout is an arrangement of templates on a sheet of CD labels. The paper that is scanned preferably has a printed outline of the templates thereon.

In the above method, step a) further comprises the steps of: a1) scanning the paper; a2) detecting a boundary of the layout of templates on the scanned paper and distinguishing the respective regions of the template layout; a3) selecting one of the distinguished regions as a printing region; and a4) identifying the selected printing region as the template.

In the above method, step a3) further comprises the step of assigning predetermined symbols to each of the distinguished regions and entering at least one of the assigned symbols for selecting the printing region.

In the above method, step a3) further comprises the step of displaying the distinguished regions on a display device and selecting at least one of the distinguished regions by using a predetermined input means.

In the above method, step a4) further comprises the step of a4-1) storing the determined template.

In the above method, step c) further comprises the step of controlling a position of the template on the paper by considering a printing starting point of a printing device for printing the template.

In the above method, step c) further comprises the step of c1) rearranging the images arranged on the template and modifying a style of the arranged image on the template.

In the above method, the paper in step a) is paper having a layout of templates designed by the user.

According to another aspect of the present invention, a print management apparatus comprises an input unit for selecting a predetermined image, and a central processing unit for issuing a print command, according to which the image selected by the input unit is arranged on a template layout of a scanned paper, and the arranged image on the template layout is printed onto the paper.

The central processing unit can detect a boundary of the template layout of the scanned paper and distinguish respective regions, and when at least one region is selected as a print region by using the input unit, determine the selected print region as the template.

The central processing unit preferably assigns and displays a symbol for each of the distinguished regions, and when at least one of the displayed symbols is entered through the input unit, determines the region corresponding to the entered symbol to be the print region.

The central processing unit preferably displays the distinguished regions, and when one of the displayed regions is selected by using the input unit, determines the selected print region to be the template.

In the provided apparatus, a storing unit can be further provided for storing the template as determined by the central processing unit.

The central processing unit can adjust the position of the template with respect to the paper in consideration of a print starting point of a particular external printing apparatus to be used.

The central processing unit can also perform rearrangement of an image position with respect to the template and modification of a style of the image.

A template layout designed by the user may be provided on paper for scanning.

According to yet another aspect of the present invention, a print system comprises an image forming apparatus for scanning a paper having a predetermined template layout and printing on paper, and a host for arranging an image, which is selected by a predetermined input means, on the template layout of the paper scanned by the image forming apparatus, and issuing a print command to the image forming apparatus to print the image arranged on the template onto the paper.

The host may detect a boundary of the template layout on the scanned paper, distinguish respective regions, and determine at least one of the distinguished regions to be the template.

### BRIEF DESCRIPTION OF THE DRAWINGS

The above aspects and features of the present invention will be more apparent by describing certain embodiments of the present invention with reference to the accompanying drawings, in which:

FIG. 1 is a flowchart showing a conventional method for printing images on a template paper;

FIGS. 2A to 2C are diagrams showing a user interface provided during execution of a conventional application for arranging an image on a predetermined template layout and printing the template with arranged image on the template paper;

FIG. 3 is a diagram illustrating a printing apparatus in accordance with an embodiment of the present invention;

FIG. 4 is a flowchart showing a method for printing images on a template paper in accordance with an embodiment of the present invention;

FIG. 5 is a detailed flowchart showing the step for generating new template from FIG. 4; and

FIGS. 6A through 6D are diagrams illustrating an exemplary user interface provided during executing an application for arranging image on a predetermined layout of templates and printing the templates with arranged images on the template paper in accordance with an embodiment of the present invention.

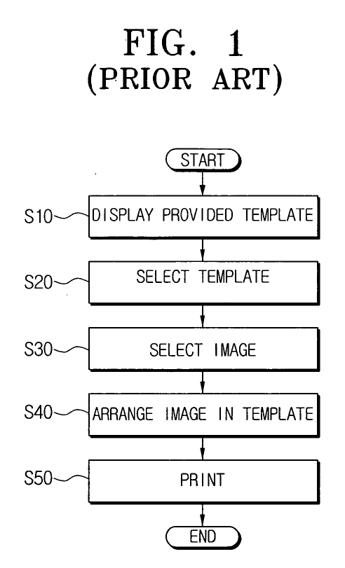

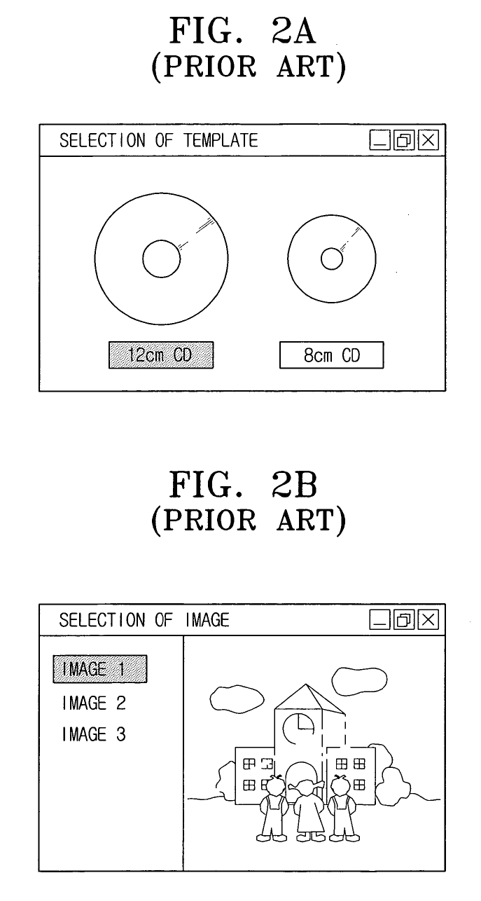

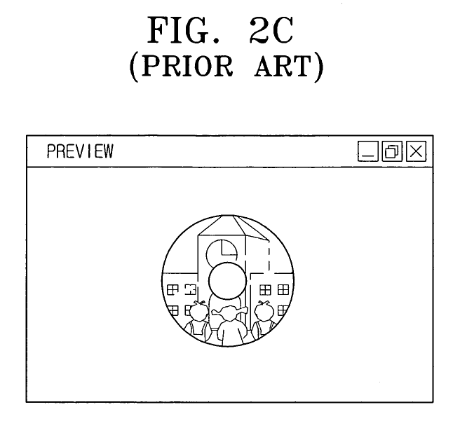

Throughout the drawings, it should be understood that like reference numerals refer to like features, structures and elements.

### DETAILED DESCRIPTION OF EXEMPLARY EMBODIMENTS

Certain embodiments of the present invention will be described in greater detail with reference to the accompanying drawings.

The matters defined in the description such as a detailed construction and elements are provided to assist in a comprehensive understanding of the invention. Thus, it is apparent that the present invention can be carried out without those defined matters. Also, desriptions of well-known functions or constructions are omitted for the sake of clarity and conciseness.

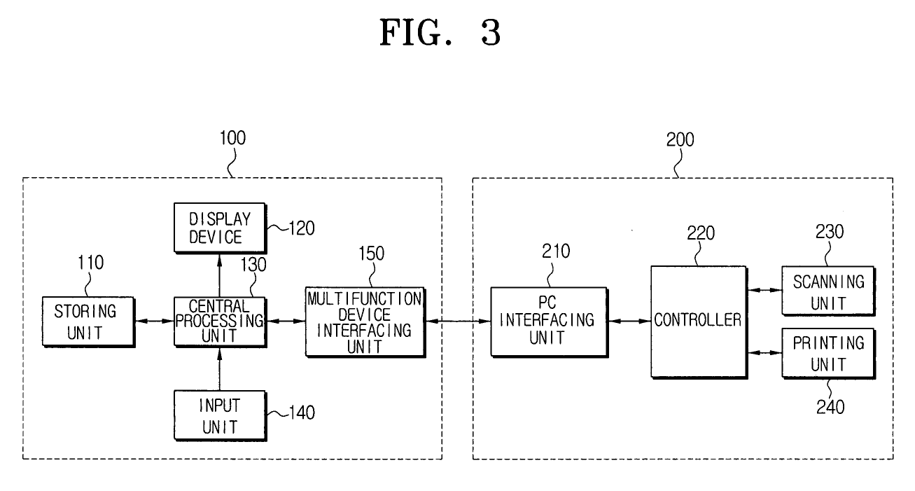

FIG. 3 is a diagram illustrating a printing apparatus in accordance with an exemplary embodiment of the present invention. Referring to FIG. 3, the printing apparatus comprises a personal computer (PC) 100, which is a host apparatus, and a multifunction device 200 connected to the PC 100 having functions for printing and scanning.

The PC 100 executes an application for designing a predetermined template and transfers printing data to the multifunction device 200 for printing the designed template. The PC 100 comprises a storing unit 110, a display device 120, a central processing unit 130, an input unit 140 and a multifunction device interfacing unit 150.

The storing unit 110 is preferably a computer readable recoding medium for storing data and instructions generally used by the PC and the application. The storing unit 110 is generally implemented by a hard disk drive. Specifically, the storing unit 110 stores the application for generating new template layouts and printing onto the template paper.

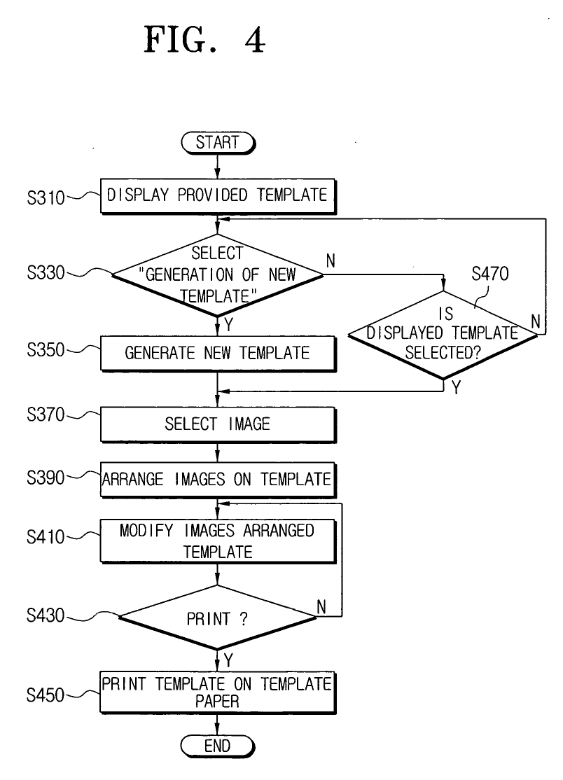

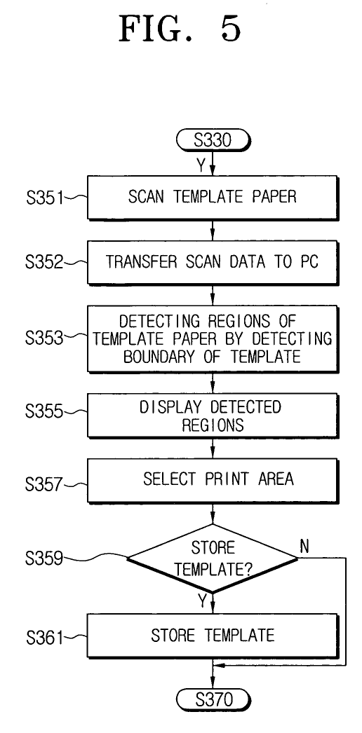

The application for printing on the template paper is preferably a software program for arranging images and text on a predetermined template layout and printing the templates with the arranged images and text produced on the corresponding template paper according to a method illustrated in FIGS. 4 and 5. A detailed explanation of the method is provided below.

The display device 120 displays templates provided by the application for printing template paper, images arranged on the templates and various user interfaces on a screen. And, the input unit 140 is an input device, such as a keyboard or a mouse, for receiving commands from a user and transferring the received commands to the central processing unit 130 for performing a predetermined operation. The multifunction device interfacing unit 150 performs data communication between the PC 100 and the multifunction device 200 based on the control of the central processing unit 130. A template is the printable region of the CD label. The layout is an arrangement of templates on a sheet of CD labels. The paper that is scanned preferably has a printed outline of the templates thereon.

The central processing unit 130 runs the application for printing the template paper stored in the storing unit 110. That is, the central processing unit 130 performs operations according to the method illustrated in FIGS. 4 and 5 for arranging images on the predetermined template and printing the template with arranged images and text.

The multifunction device 200 preferably performs a scanning function and a printing function. The multifunction device 200 comprises a PC interfacing unit 210, a controller 220, a scanning unit 230 and a printing unit 240.

The PC interfacing unit 210 performs data communication between the PC 100 and the multifunction device 200 according to the control of the controller 220. The scanning unit 230 scans a target paper, reads image data on the scanned paper, performs a predetermined signaling process on the read image data and generates scan data as a result of the signaling process. The printing unit 240 receives printing data from the PC 100 and prints the received printing data on a paper according to the control of the controller 220.

The controller 220 controls the communication operations of the PC interfacing unit 210, a scanning operation of the scanning unit 230 and a printing operation of the printing unit 240. In more detail, the controller 220 transfers the scan data generated from the scanning unit 230 to the PC 100 through the PC interfacing unit 210. Also, the controller 220 controls the printing unit 220 to print the printing data received from the PC 100 through the PC interfacing unit 210.

Hereinafter, a method for printing images and text on a template paper by using the printing apparatus shown in FIG. 3 is explained. FIG. 4 is a flowchart showing a method for printing an image on a user generated template paper in accordance with an embodiment of the present invention.

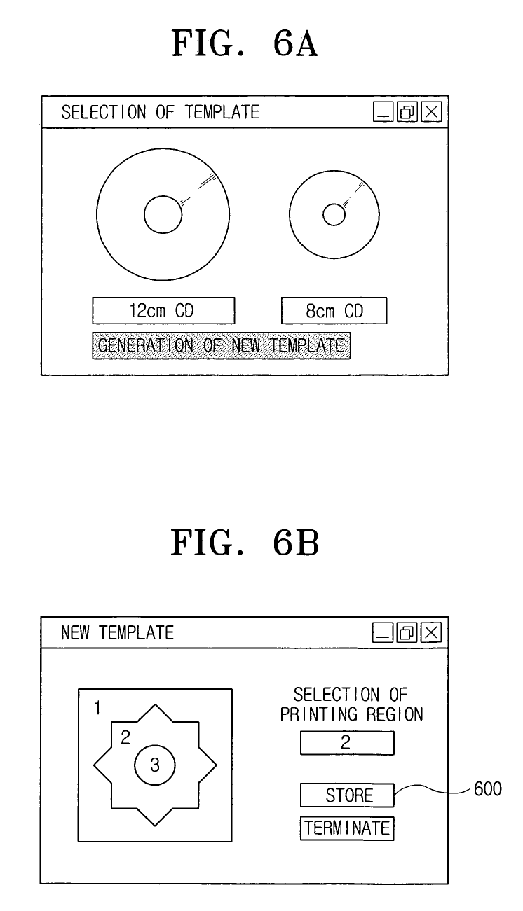

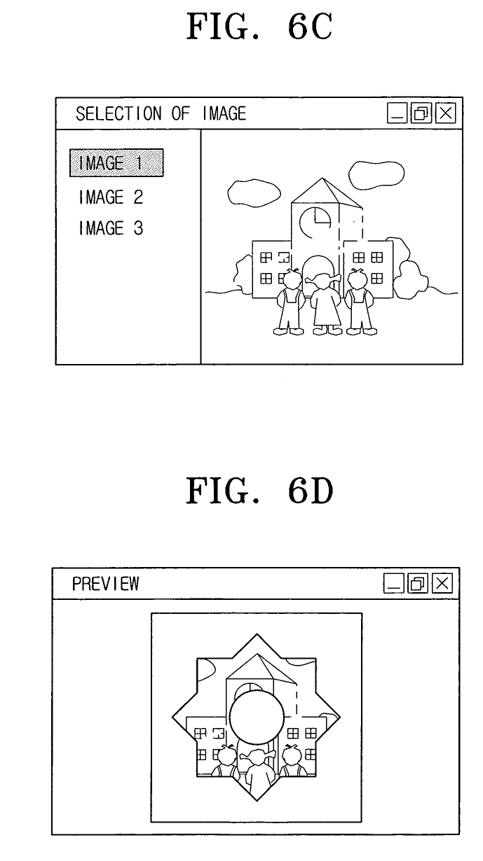

First, a user executes an application for printing a template paper (hereinafter application) at the PC 100 and a first “selection of template” window is displayed at the displayer 120. In the first window, templates provided from the application are displayed at step S310. The first window is shown in FIG. 6A.

As shown in FIG. 6A, there are three icons displayed on the first “selection of template” window. Two icons are provided for selecting a template of “12 cm CD” or another template of “8 cm CD” and one icon is provided for generating a new template. The user can select one of the three icons by using the input unit 140.

If the user selects the icon for generating a new template at step S330, the PC 100 generates a new template which is not yet provided by the application at step S350. If the user selects one of the two icons representing to select existing templates provided by the application at step 470, the PC uses the selected template provided by the application.

Hereinafter, the step S350 for generating a new template is explained with reference to the FIG. 5.

FIG. 5 is a detailed flowchart showing the step for generating a new template in FIG. 4. Referring to FIG. 5, the user scans a template paper including a desired template layout by using the scanning unit 230 at step S351. In the step S352, the generated scan data is transferred to the PC 100 through the PC interfacing unit 210.

The central processing unit 130 of the PC 100 detects a boundary of the template by using the scan data received through the multifunction apparatus interfacing unit 150 and recognizes any divided regions on the template paper by using the detected boundary of the template at step S353. The recognition of any divided regions can be performed by various well-known methods.

The central processing unit 130 displays a second “new template” window at the display device 120 at step S355. In the second window, a new template having divided regions is displayed. An exemplary second window is shown in FIG. 6B.

As shown in FIG. 6B, at a left side of the second window, the scanned template paper is displayed and numeral references (1, 2, and 3) are assigned to each of the divided regions in the scanned template paper.

The user selects one of divided regions on the template paper as a printing region for printing an image on the selected region at step S357. In greater detail, a printing region can be selected by using an input box in the second “new template” window. The input box is provided on a right upper side of the second window and the user can select a desired region by inputting the numeral reference assigned to the desired region in the input box. Alternatively, instead of using the input box, the desired regions can be selected by using a mouse to click the desired region on the second window. Of course, these are exemplary selection methods and any other suitable selection method can be employed.

FIG. 6B shows an example of selecting one printing region having numeral reference 2. However, the preferred embodiment of the present invention is not limited to selecting only one printing region. It is possible to select multiple printing regions.

When the user inputs an order for storing the template at step S359, the template generated according to the above mentioned steps is stored in the storing unit 110 at step S361. In greater detail, the user stores the generated template by clicking an icon 600 for performing the storing operation provided in the second “new template” window.

By storing the generated template at the storing unit 110 as mentioned above, the newly generated template can be reused without scanning the template paper again. If the user does not want to store the generated template, the user selects an icon for termination, which is preferably at the right bottom side of the second window.

Referring back to FIG. 4, when the generation of the new template S350 or the selection of displayed template S470 is accomplished, the central processing unit 130 displays a third “image selection” window on the display device 120 and the user selects one of the images by using the third window at step S370. An exemplary third window of “image selection” is shown in FIG. 6C.

As shown in FIG. 6C, a list of images is preferably displayed at the left side of the third window and a selected image is preferably displayed at a right side of the third window.

After selecting an image, the central processing unit 130 arranges the selected images on the selected template or the generated template at step S390. The result of arranging step is displayed at a fourth “preview” window so the user can preview the selected or generated template with the arranged images. The fourth “preview” window is shown in FIG. 6D.

The central processing unit 130 arranges the positions of templates on the template paper displayed at the display device 120 and arranges the images on the templates by considering characteristics of the multifunction device 200. In greater detail, the central processing unit 130 controls the position of template on the template paper by considering a print starting point of the printing unit 240 of the multifunction apparatus 200.

The central processing unit 130 controls the position of the template on the template paper for eliminating printing error caused by differences between the template position in the template paper displayed on the fourth window and the template position of the printed template paper. The application of an embodiment of the present invention can reflect the characteristics of a predetermined multifunction device because the application of an embodiment of the present invention is produced according to the characteristics of multifunctional apparatus.

The user rearranges the arranged images, inserts text and has the ability to control the contrast and the color of the images by previewing the template with arranged images and text in the fourth “preview” window at step S410.

After completing the modification of the template, the user inputs a command to print at step S430 and the printing unit 240 of the multifunction device 200 prints the template with the arranged images and text on the template paper at step S450.

In the preferred embodiment of the present invention, the printing apparatus comprising the PC 100 and the multifunction device 200 is explained as a printing system in which an embodiment of the present invention can be implemented. However, the present invention is not limited to the foregoing printing apparatus. The PC 100 can be replaced with any other apparatus which can execute the application and the multifunction device 200 can be replaced with any other apparatus which can perform a printing function and a scanning function instead of using a printer and a scanner. The template with arranged images and text can also be stored in memory via the storing unit 110.

As mentioned above, embodiments of the present invention provide conveniences to a user. The user does not need to install additional applications when the user wants to use different types of template paper. Also, the user can arrange images and text on templates which are not provided with the application or on a template designed by the user, and print the template with arranged images and text on the template paper provided by the template paper manufacturer or designed by the user. Furthermore, the user can print the images or text on the template paper in the case where the user does not have the application provided from the manufacturer of the template paper. Moreover, the difference between the position of the image on the template displayed at a display device and the position of image on the template printed on the template paper, can be reduced.

The foregoing embodiments and advantages are merely exemplary and are not to be construed as limiting the present invention. The present teachings can be readily applied to other types of apparatuses. Also, the description of the embodiments of the present invention is intended to be illustrative, and not to limit the scope of the claims, and many alternatives, modifications, and variations will be apparent to those skilled in the art.

1. A method of printing, comprising the steps of:
a) scanning a paper having a predetermined templates layout;
b) selecting a predetermined image;
c) arranging the selected image on a template from the scanned template layout; and
d) printing the template with the arranged image on the paper.

2. The method of claim 1, wherein step a) further comprises the steps of:
a1) scanning the paper;
a2) detecting a boundary of the layout of templates on the scanned paper and distinguishing the respective regions of the template layout;
a3) selecting one of the distinguished regions as a printing region; and
a4) identifying the selected printing region as the template.

3. The method of claim 2, wherein step a3) further comprises the steps of:
assigning predetermined symbols to each of the distinguished regions; and
entering at least one of the assigned symbols for selecting the printing region.

4. The method of claim 2, wherein step a3) further comprises the step of:
displaying the distinguished regions at a display device and at least one of the distinguished regions is selected by using a predetermined input means.

5. The method of claim 2, wherein step a4) further comprises the step of:
a4-1) storing the determined template.

6. The method of claim 1, wherein step c) further comprises the step of:
controlling a position of template on the paper by considering a printing starting point of a printing device for printing the template.

7. The method of claim 1, wherein step c) further comprises the step of:
c1) rearranging the images arranged on the template and modifying a style of the arranged image on the template.

8. The method of claim 1, wherein the paper in the step a) is the paper having a layout of templates designed by the user.

9. A print management apparatus, comprising:
an input unit for selecting a predetermined image; and
a central processing unit for issuing a print command, according to which the image selected by the input unit is arranged a template layout on a scanned paper, and the arranged image on the template is printed onto the paper.

10. The print management apparatus of claim 9, wherein the central processing unit detects a boundary of the template layout on the scanned paper and distinguishes respective regions of the template layout, and when at least one region is selected as a print region by using the input unit, determines the selected print region as the template.

11. The print management apparatus of claim 10, wherein the central processing unit assigns and displays a symbol for each of the distinguished regions, and when at least one of the displayed symbols is entered through the input unit, determines the region corresponding to the entered symbol to be the print region.

12. The print management apparatus of claim 10, wherein the central processing unit displays the distinguished regions, and when one of the displayed regions is selected by using the input unit, determines the selected print region to be the template.

13. The print management apparatus of claim 10, further comprising a storing unit for storing the template as determined by the central processing unit.

14. The print management apparatus of claim 9, wherein the central processing unit adjusts the position of the template with respect to the paper in consideration of a print starting point of an external printing apparatus to be used to print the arranged image on the paper.

15. The print management apparatus of claim 9, wherein the central processing unit rearranges the image position with respect to the template and the style of the image.

16. The print management apparatus of claim 9, wherein a layout of templates designed by the user is on the paper.

17. The print management apparatus of claim 9, wherein the template layout on a scanned paper is retrieved from a storing unit, which stores previously scanned papers having template layouts thereon.

18. A print system comprising:
an image forming apparatus for scanning a paper having a predetermined layout of templates and printing on the paper; and
a host for arranging an image, which is selected by a predetermined input means, on the layout of templates of the paper scanned by the image forming apparatus, and issuing a print command to the image forming apparatus to print the image arranged on the template onto the paper.

19. The print system of claim 18, wherein the host detects a boundary of the layout of templates of the scanned paper, distinguishes respective regions, and determines at least one of the distinguished regions to be the template.

20. The print system of claim 19, wherein the host adjusts the position of the template with respect to the paper in consideration of a print starting point of the image forming apparatus to be used to print the arranged image on the paper.
